(19) United States
(12) Patent Application Publication
(10) Pub. No.: US 2022/0312741 A1
(43) Pub. Date: Oct. 6, 2022

(54) PET COLLAR

(71) Applicants: Morgan Hathaway, Hanahan, SC (US); Alden M. Hathaway, III, Hanahan, SC (US)

(72) Inventors: Morgan Hathaway, Hanahan, SC (US); Alden M. Hathaway, III, Hanahan, SC (US)

(21) Appl. No.: 17/579,647

(22) Filed: Jan. 20, 2022

Related U.S. Application Data
(60) Provisional application No. 63/167,982, filed on Mar. 30, 2021.

(51) Int. Cl. A01K 27/00

(52) U.S. Cl. CPC A01K 27/001

(57) ABSTRACT

A leashed collar for a dog or pet having individual links that connect and form the structure of the collar. Links may be easily added or removed for length adjustability. The collar is structured for adding a martingale attachment in one embodiment. Other decorative and ornamental articles can be added to the collar, such as jewelry.

The collar has a plurality of links, with each link comprising an upper horizontal member, and vertical legs. The vertical legs are spaced apart from each other and extend generally parallel to each other. A plurality of connectors has vertical voids extending there through. Vertical legs of the links extend through the vertical voids of the connectors. Lower horizontal members engage a vertical leg of the links to hold the construct together.

### BACKGROUND OF THE INVENTION

Collars are positioned on the necks of pet to provide a means for attaching a leash to the pet, and also to provide identification of the pet. Pet collars may be ornamental, and may hold items of jewelry. There is a need for a collar that is strong and is length adjustable as a pet grows, and which also allows addition of ornamentation or jewelry or other articles to the collar.

### SUMMARY OF THE INVENTION

The present invention is a leashed collar for a dog or pet having individual links that connect and form the structure of the collar. Links may be easily added or removed for length adjustability. The collar is structured for adding a martingale attachment in one embodiment. Other decorative and ornamental articles can be added to the collar, such as jewelry.

The collar has a plurality of links, with each link comprising an upper horizontal member, and vertical legs. The vertical legs are spaced apart from each other and extend generally parallel to each other. A plurality of connectors has vertical voids extending there through. Vertical legs of the links extend through the vertical voids of the connectors. Lower horizontal members engage a vertical leg of the links to hold the construct together.

### DESCRIPTION OF THE DRAWINGS

FIG. 1 is an isometric view of an assembled collar with a leash loop.

FIGS. 2A-2D show a sequential process for forming the collar by attaching links together according to a preferred embodiment.

FIG. 3 is an isometric view of the collar having a martingale attachment attached.

### DESCRIPTION OF THE INVENTION

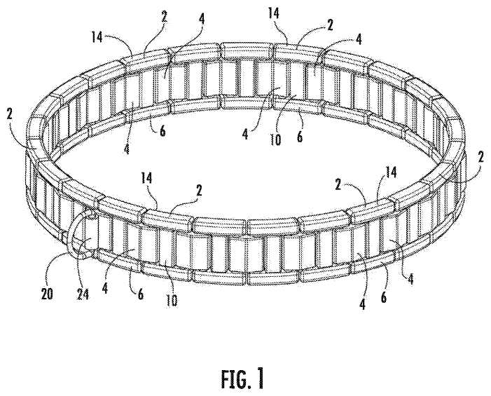

FIG. 1 shows an assembled pet collar according to an embodiment of the invention. The collar may be constructed of a series of links that are connected together in a selected quantity to form a collar of the desired circumference.

The collar as shown in FIG. 1 is comprised of a plurality of links 2 and a plurality of connectors 4. The links have legs that pivotally engage voids formed the adjoining connectors. Each link pivotally engages two connectors as shown in FIG. 1, with adjoining links engaging one of the connectors.

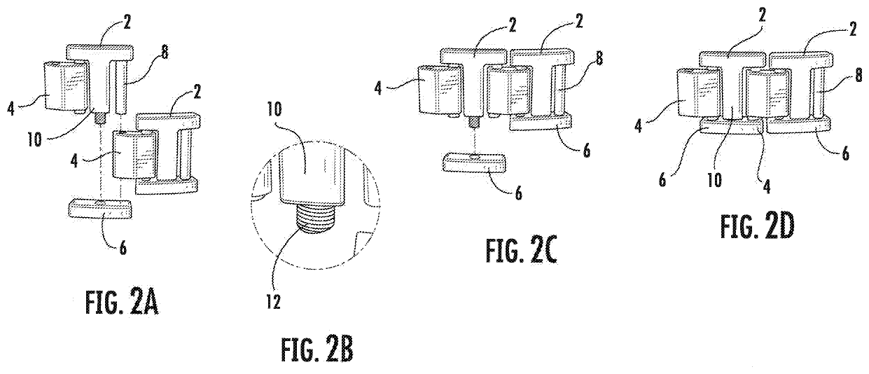

An example of assembly of the collar is shown in FIG. 2. The link 2 has a generally horizontal top member 14. Three legs 8,10 extend generally vertically from the top member. The center leg 10 in this embodiment has a threaded member 12 on an end of the center leg that is opposite the top member.

Connectors 4 engage links 2 in a male-female relationship. One of the legs 8 of the link is inserted through a first void in the connector. The voids of the connector and the height of the connector are preferred to be shorter than the length of the legs of the connector, and of slightly larger radius, to allow the link and the connector to pivot relative to each other. The connector comprises a first void and a second void, and the legs of the link are inserted into a void of the adjoining connectors.

A lower horizontal member 6 is attached to each of the links 2, such as by a threaded engagement of the lower horizontal member with the threads 12 of the center leg 10 of the link. FIG. 2A-2C. The lower horizontal member extends to each side of the center leg 10 and under each of the lateral legs 8 of the link. When the collar is assembled, the lower horizontal member extends under a portion of the attached connector 4 and holds the connector in position relative to the link. Sufficient links 2,4 and lower horizontal members are used to provide a continuous collar of desired length, as demonstrated in FIG. 1. The lower horizontal members are preferred to have generally the same height, length and width as the upper horizontal member of the links 2, so that the lower horizontal members and the upper horizontal member of the links have the same appearance when the collar is assembled.

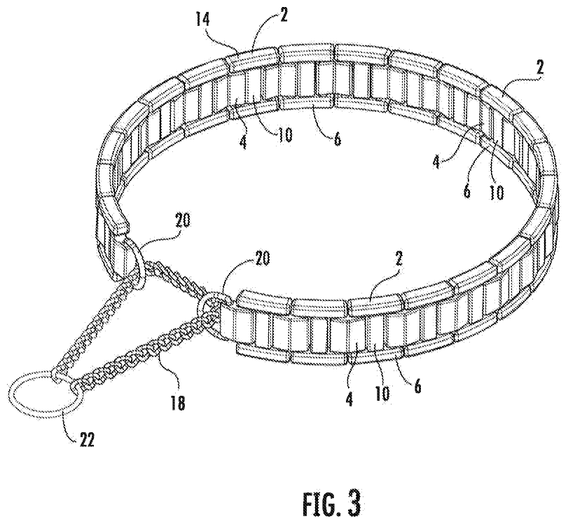

FIG. 3 shows the pet collar with a martingale attachment 18. The martingale attachment in this embodiment is representative of any accessory that can be attached to the collar. In this embodiment, the martingale attachment links the remainder of the collar and becomes part of the collar. A ring 20 is inserted into end void of the connector rather than having a link to attach the ends of the collar. In the embodiment of FIG. 3, a chain is looped through, but is not attached to, the rings 20, so that the chain can move or slide through the rings. A ring 22 is attached to each end of the chain. A leash may be attached to the ring, so that the construct forms a martingale attachment. Pulling on the leash moves the chain, belt, line, or other similar devices through the rings and tightens the collar by pulling the ends of the links and connectors construct closer together to help control a pet that is wearing the collar.

The rings 20,22 may be used to hold a chain in place as shown, or the rings may be used to hold other articles, such as identification tags, decorations and/or straps on the collar. Devices and accessories may be inserted through the voids of the connectors and provide connection of ends of the collar. The rings are preferred to be D shaped rings, known as D rings, have a straight side and an arcuate side, with an opening between theses sides into which leashes, jewelry, chains and other devices pass. The straight side of the D rings may be positioned within the generally vertical and straight void of the connectors 4 that extends beyond the links 2, as shown in FIG. 3.

In the embodiment of FIG. 1, ring 20, which may be a D ring, is inserted through a connector 24 having a third void centrally positioned on the connector and through which the ring is inserted and held. A leash may be attached to the ring 20, or other articles such as tags or decorative jewelry may be attached to the ring. The straight side of the D ring is positioned within the generally vertical and straight void of connector 24.

One advantage of the invention is the strength of the link and connector design. The threaded rod forming leg 10 of the link 2, the lower horizontal member 6, and male-female engagement of the link and connector 4 create a strong connection between each link such that owners can add and remove links to form a custom fit for a dog or pet, while maintaining a strong connection around the circumference of the collar. This strength is also maintained when accessories with the same integrated link design are attached and the collar and accessory become a single unit.

What is claimed is:

1. A collar comprising,
a plurality of links, each link comprising an upper horizontal member and three vertical legs, the vertical legs being spaced apart from each other and extending generally parallel to each other, and a lower horizontal member, a lower end of a center vertical leg of the three vertical legs engaging the lower horizontal member and connecting the lower horizontal member to the central vertical leg;
a plurality of connectors, each connector having two vertical voids extending there through, wherein one of the vertical legs of a first link of the plurality of links extends through one of the vertical voids of one of the connectors and one of the vertical legs of an adjoining link of the plurality of links extends through the other vertical void of the one of the connectors, wherein the one of the connectors connects the first link to the adjoining link, and the upper horizontal member of the first link and the upper horizontal member of the second link and the lower horizontal member of the first link and the lower horizontal member of adjoining link hold the connector in position to connect the first link with the adjoining link.

2. A collar comprising a plurality of links and connectors as described in claim 1, wherein the collar so formed has a first end and a second end, wherein the first end comprises a connector retained in position by a link of the plurality of links and a portion of the connector comprising a vertical void extends beyond the link, and the second end comprises a connector retained in position by another link of the plurality of links and a portion of the connector comprising a vertical void extends beyond the link, and
further comprising a martingale attachment that engages the connector of the first end of the collar and the second end of the collar and connects the first end of the collar to the second end of the collar.

3. A collar comprising a plurality of links and connectors as described in claim 1, wherein the collar so formed has a first end and a second end, wherein the first end comprises a connector retained in position by a link of the plurality of links and a portion of the connector comprising an vertical void extends beyond the link, and the second end comprises a connector retained in position by a link of the plurality of links and a portion of the connector comprising an vertical void extends beyond the link,
a first ring that engages the vertical void of the connector of the first end that extends beyond the link and a second ring that engages the vertical void of the connector of the second end that extends beyond the link, and
further comprising a martingale attachment that extends through the first ring and extends through the second ring.

4. A collar comprising a plurality of links and connectors as described in claim 1, wherein the collar so formed has a first end and a second end, wherein the first end comprises a connector retained in position by a link of the plurality of links and a portion of the connector comprising an vertical void extends beyond the link, and the second end comprises a connector retained in position by a link of the plurality of links and a portion of the connector comprising an vertical void extends beyond the link,
a first ring that engages the vertical void of the connector of the first end that extends beyond the link and a second ring that engages the vertical void of the connector of the second end that extends beyond the link, and
further comprising a martingale attachment that extends through the first ring and extends through the second ring, wherein the martingale attachment slides relative to the first ring and the second ring, the martingale attachment having a first end that is attached to a third ring and a second end that is attached to the third ring.

5. A collar as described in claim 1, wherein the plurality of links is connected by the plurality of connectors as described in claim 1 to form a collar of sufficient overall length to surround the neck of a pet.

6. A collar as described in claim 1, wherein the plurality of links is connected by the plurality of connectors as described in claim 1 to form a continuous collar of links and connectors of sufficient overall length to surround the neck of a pet.

7. A collar as described in claim 1, wherein a lower end of the center vertical leg of the three vertical legs of the link is positioned in a void formed in the lower horizontal member and connects the lower horizontal member to the central vertical leg.

8. A collar as described in claim 1, wherein the center vertical leg of the three vertical legs engages the lower horizontal member by a threaded relationship and connects the lower horizontal member to the central vertical leg.

9. A collar comprising a plurality of links and connectors as described in claim 1, wherein the connector pivots relative to the vertical leg of the first link and relative to the vertical leg of the adjoining link.

10. A collar comprising a plurality of links and connectors as described in claim 1, wherein the upper horizontal member of each of the plurality of links has substantially the same height, length and width as the lower horizontal member.

11. A collar comprising a plurality of links and connectors as described in claim 2, wherein the first ring and the second ring are D shaped rings, and a straight side of the D shaped rings are positioned within the vertical voids of the connectors.

12. A collar comprising a plurality of links and connectors as described in claim 1, wherein the collar is formed as a closed loop, and one of the connectors of the plurality of connectors comprises a third vertical void.

13. A collar comprising a plurality of links and connectors as described in claim 1, wherein the collar is formed as a closed loop, and one of the connectors of the plurality of connectors comprises a third vertical void, and the collar further comprises a ring positioned in the third vertical void of the one of the connectors

14. A collar comprising a plurality of links and connectors as described in claim 13, wherein the ring is a D shaped ring, and a straight side of the D shaped ring is positioned within the third vertical void of the one of the connectors.
